(19) United States
(12) Patent Application Publication
(10) Pub. No.: US 2014/0310802 A1
(43) Pub. Date: Oct. 16, 2014

(54) Electronic Apparatus and Control Method

(71) Applicant: KABUSHIKI KAISHA TOSHIBA, Tokyo (JP)

(72) Inventors: Terunobu Hara, Ome-shi (JP); Toshimitsu Saito, Fuchu-shi (JP)

(73) Assignee: KABUSHIKI KAISHA TOSHIBA, Tokyo (JP)

(21) Appl. No.: 14/184,214

(22) Filed: Feb. 19, 2014

(30) Foreign Application Priority Data
Apr. 15, 2013 (JP) 2013-085230

(51) Int. Cl. G06F 21/36

(52) U.S. Cl. CPC G06F 21/36
USPC 726/19

(57) ABSTRACT

An electronic apparatus includes a main body, a sensor, an input unit and an authentication unit. The sensor detects a tilt of the main body. The input unit accepts entry of a password from a user. The authentication unit executes user authentication based on the tilt detected by the sensor and the password entered in the input unit. In a control method in an electronic apparatus including a main body, a sensor detecting a tilt of the main body, and an input unit accepting entry of a password from a user, the control method includes: detecting a tilt of the main body; and executing user authentication based on the detected tilt and the entered password.

### CROSS-REFERENCE TO RELATED APPLICATION(S)

This application is based upon and claims the benefit of priority from Japanese Patent Application No. 2013-085230, filed on Apr. 15, 2013; the entire contents of which are incorporated herein by reference.

### FIELD

Embodiments described herein relate generally to an electronic apparatus and a control method.

### BACKGROUND

In an information terminal such as an electronic apparatus, a password input method incorporates various ideas. For example, there is a technology such as adding a direction of a terminal on top of a common login ID and login password, all of which will be used for login authentication (user authentication).

However, although there is a demand for a simple user authentication technology which is difficult to be noticed by a third party, means to realize such a demand has not been found.

### BRIEF DESCRIPTION OF THE DRAWINGS

FIG. 1 is a schematic diagram showing an external appearance of an electronic apparatus according to an embodiment.

FIG. 2 is a block diagram showing an example of a hardware configuration of an electronic apparatus according to an embodiment.

FIG. 3 is a functional block diagram showing an example of an information terminal according to the same embodiment.

FIG. 4 is a flowchart for explaining operations of the same embodiment.

FIG. 5 shows an example of user's operation when combining a direction and tilt of an information terminal used in the same embodiment into five patterns, and using them as a password.

FIG. 6 shows a modification of display to know a tilt of an embodiment.

FIG. 7 shows a modification of display of orientation to know a direction of an embodiment.

### DETAILED DESCRIPTION

According to one embodiment, an electronic apparatus includes a main body, a sensor, an input unit and an authentication unit. The sensor detects a tilt of the main body. The input unit accepts entry of a password from a user. The authentication unit executes user authentication based on the tilt detected by the sensor and the password entered in the input unit.

Various embodiments will be described hereinafter with reference to the accompanying drawings.

### First Embodiment

An electronic apparatus and a control method according to embodiments will be explained in detail with reference to the accompanying drawings.

The following description of embodiments assumes an electronic apparatus which is functioning as a signal processing apparatus having display processing, such as a PDA, a cellular phone, a handheld or wearable electronic apparatus.

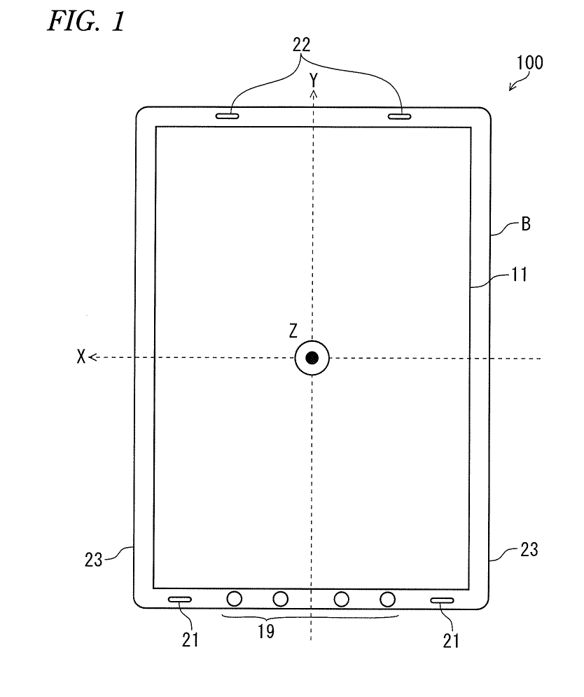

FIG. 1 is a schematic diagram showing an external appearance of an electronic apparatus 100 according to an embodiment. The electronic apparatus 100 is an information processing apparatus having a display screen, and is realized as a slate terminal (a tablet terminal), an electronic book reader, a digital photo frame, or the like. Here, the directions of X, Y and Z axes are assumed to be forward directions (Z axis represents a front direction in the drawing) (hereinafter, the same).

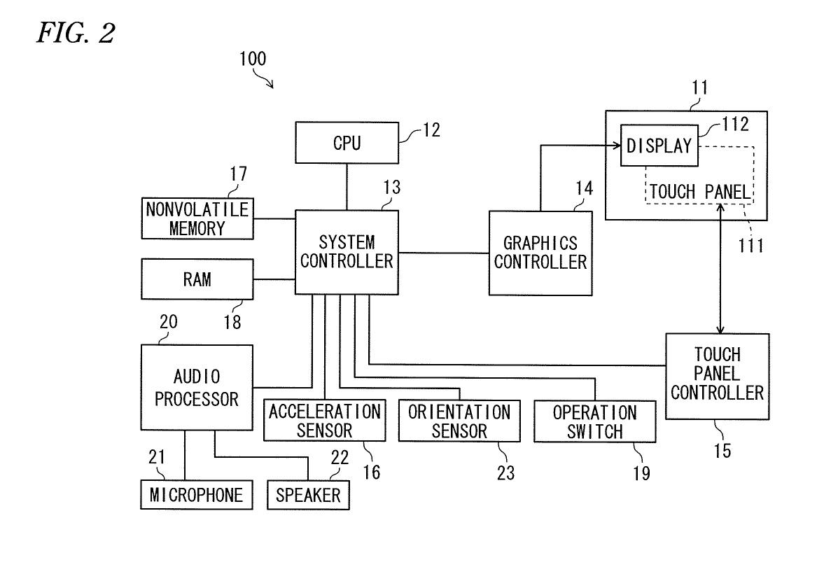

The electronic apparatus 100 is provided with a low-profile box-shaped housing B. A display unit 11 is disposed on the upper surface of the housing B. The display unit 11 is provided with a touch panel that detects a position on a display screen touched by a user (refer to FIG. 2, a touch panel 111). In the front lower part of the housing B, operation switches 19 used by a user to perform various operations, and microphones 21 to catch a user's voice are arranged. In the front upper part of the housing B, speakers 22 are disposed to output sound. In the edge portion of the housing B, orientation sensors 23 are disposed to detect an orientation on the ground to recognize a direction of an electronic apparatus held by a user. Although an orientation sensor 23 is provided in both side edge portions in the X-axis direction in the example shown in the drawing, the orientation sensor 23 may be provided in upper and lower edge portion in the Y-axis direction. By providing more than one orientation sensor 23, it is possible to sense bending and folding postures when the electronic apparatus 100 is configured to have flexibility. The orientation sensor 23 is a (electronic) compass, and may use a gyrocompass or a magnet compass.

FIG. 2 is a block diagram showing an example of a hardware configuration of an electronic apparatus 100 according to an embodiment. As shown in FIG. 2, in addition to the configuration described above, the electronic apparatus 100 includes a CPU 12, a system controller 13, a graphics controller 14, a touch panel controller 15, an acceleration sensor 16, a nonvolatile memory 17, a RAM 18, and an audio processor 20.

The display unit 11 includes a touch panel 111, and a display 112 such as a liquid crystal display (LCD) or an electro luminescence (EL). The touch panel 111 includes an immediate coordinate detection device disposed on a display screen of a display 112, for example. The touch panel 111 can detect a position (a touch position) on a display screen touched by a finger of a user who is holding the housing B, for example. By the operation of the touch panel 111, a display screen of the display 112 functions as a so-called touch screen.

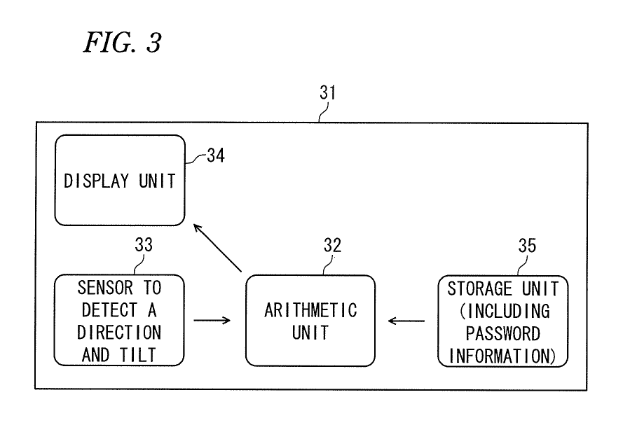

The CPU 12 is a central processor to control the operation of the electronic apparatus 100, and controls each unit of the electronic apparatus 100 through the system controller 13. The CPU 12 realizes each functional unit described later (refer to FIG. 3) by executing an operating system and various application programs to be loaded from the nonvolatile memory 17 to the RAM 18. The RAM 18 is functioning as a main memory of the electronic apparatus 100, and provides a work area for the CPU 12 to execute programs.

The system controller 13 incorporates a memory controller to control access to the nonvolatile memory 17 and RAM 18. The system controller 13 is also provided with a function of executing communication with the graphics controller 14.

The graphics controller 14 is a display controller to control the display 112 used as a display monitor of the electronic apparatus 100. The touch panel controller 15 controls the touch panel 111, and obtains coordinate data indicating a position that was touched by a user on the display screen of the display 112 from the touch panel 111.

The acceleration sensor 16 is a sensor of acceleration in three axial directions (X, Y, Z) shown in FIG. 1 and in six axial directions including detections of rotations around each axis, detects the direction and magnitude of acceleration caused by an external force given to the electronic apparatus 100, and outputs them to the CPU 12. In particular, the acceleration sensor 16 outputs an acceleration signal (tilt information) including an acceleration detected axis, direction (a rotational angle in case of rotation) and magnitude to the CPU 12. The acceleration sensor 16 may be integrated with a gyro sensor for detecting an angular velocity (a rotational speed). Such an acceleration sensor 16, detecting also a gravity acceleration, can detect a tilt of the electronic apparatus 100 to the ground.

The audio processor 20 performs audio processing such as digital conversion, noise rejection, and echo cancellation for an audio signal input from the microphone 21, and outputs an obtained signal to the CPU 12. The audio processor 20 outputs an audio signal, which is generated by performing audio processing such as voice synthesis under the control of the CPU 12, to the speaker 22, and makes a voice notification by the speaker 22.

FIG. 3 is a functional block diagram of an information terminal in an embodiment. An information terminal 31 is a main body of an information terminal, and corresponds to the electronic apparatus 100. The information terminal 31 includes, as functions, an arithmetic unit 32, a sensor 33 to detect an orientation and tilt, a display unit 34, and a storage unit 35.

As for a particular configuration of the information terminal 31, the arithmetic unit 32, as an active part, includes a CPU 12, a system controller 13, and a RAM 18. Likewise, the sensor 33, detecting a direction (orientation, tilt), includes an acceleration sensor 16, and an orientation sensor 23. The display unit 34 includes a graphics controller 14, a display 11, and a touch panel controller 15. The storage unit 35 includes a nonvolatile memory 17, and a RAM 18.

The sensor 33, detecting an orientation and a tilt, sends data thereof to the arithmetic unit 32. According to the data from the arithmetic unit 32, at the timing of entering a password, the display unit 34 displays the direction of the information terminal 31, the tilt of the information terminal 31, and the number of times determining thereof. The storage unit 35 stores data representing plural combinations of orientations and tilts as a password set for the information terminal 31. For storing the data, it is possible to employ a normal input way of registration such as using a software keyboard as an input unit to accept a password from a user, where only exception is the number of characters and character types that is limited within the number of the combinations from the orientations and tilts to be possibly taken.

As for a registration of characters for use of a password setting, for example, there is a method of displaying a direction and tilt corresponding to a certain digit of a password in each timing of entering the character of a password. In this method, it is also possible to issue an alert and demand a user to reenter a character of the digit when the character is different from the one entered previously under a condition of the same direction and tilt, or when the same character is entered twice under a condition of different direction and tilt. In the latter case, it is possible to display that, without demanding, the entry is corrected to the direction that was previously input.

Further, there is another method of selecting a corresponding direction and tilt each time after one character of the digit of a password is entered, or selecting a corresponding directions and tilts collectively after characters of all the digits are entered. It is desirable to prepare buttons capable of selecting a direction and tilt in order to display an entry for confirmation each time a user makes selection.

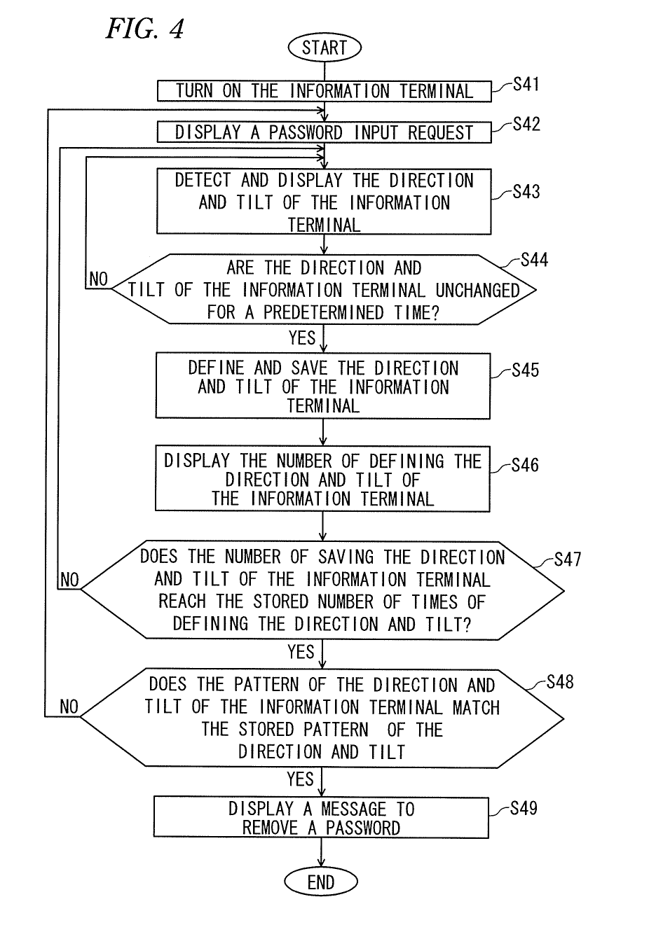

FIG. 4 is a flowchart of operations of an embodiment.

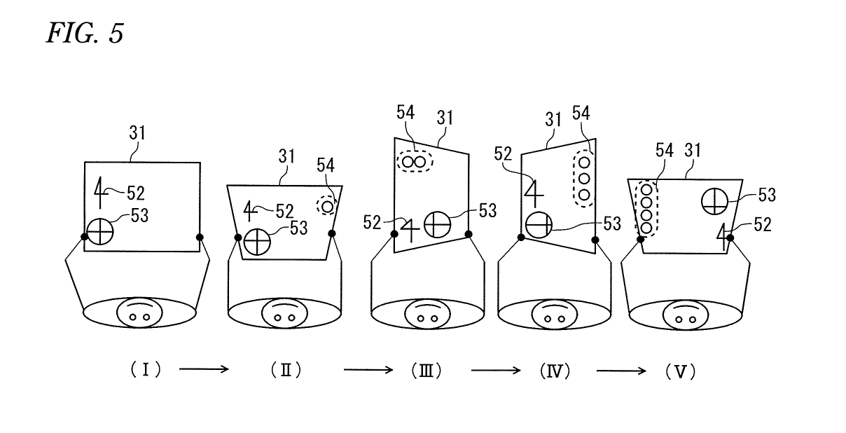

Step S41: When removing a password, a user turns on the power supply of the information terminal 31.
Step S42: The arithmetic unit of the information terminal 31 confirms that a password was already registered in the storage unit 35, and displays a message prompting to enter a password in the display unit 34. When a password has not been registered yet, exit the processing flow, and restart the operating system (OS). A user of the information terminal 31 operates it to have initial direction and tilt of the information terminal 31 (refer to (II) of FIG. 5).

Step S43: The arithmetic unit 32 of the information terminal 31 obtains information of direction and tilt from the sensor 33, detecting a direction and tilt, and causes the display unit 34 to display the information of direction and tilt of the information terminal 31.

Step S44: When the user operating the information terminal 31 sets a direction and tilt of the information terminal 31, and holds the setting for a certain time (for example, a few seconds), the arithmetic unit 32 goes to the next step, otherwise, returns to step S43.

Step S45: The arithmetic unit 32 determines a direction and tilt of the information terminal 31, and temporarily stores them in the storage unit 35 of the information terminal 31.

Step S46: The arithmetic unit 34 of the information terminal 31 displays the determined a number (digit) in the display unit 34 so that the user can know the number of determined times for the direction and tilt of the information terminal 31.

Likewise, the user of the information terminal 31 operates the information terminal 31 to change its direction and tilt so that the combination thereof matches a pattern of the password (refer to FIG. 5(I) to (V)). At this time, the arithmetic unit 32, the sensor 33 to detect an orientation and tilt, and the storage unit 35 are associated each others so as to be functioning as a so-called authentication unit to execute user authentication.

Step S47: When the number of determined times for a direction and tilt of the information terminal 31 is the same as that of being previously stored in the patterns of directions and tilts of the password, the information terminal 31 terminates the entry of the direction and tilt, and goes to the next step, otherwise, returns to step S43.

Step S48: The arithmetic unit 32 compares and checks whether the entered direction and tilt of the information terminal 31 match the direction and tilt in the pattern of the previously stored password. When they are matched, the arithmetic unit displays a message of a release by the password in the display unit 34 of the information terminal 31 (step S49), and terminates the processing. Otherwise, return to step S42. Namely, when the entered direction and tilt of the information terminal 31 are not identical to the direction and tilt in the pattern of the previously stored password, the arithmetic unit 32 returns to the step before prompting to input of a password, and repeats the operation.

When a wrong digit is entered, a cancellation function may be made by an operation such as a quick rotation on the X-Y plane or a quick tilt change. In other words, a wrong entry can be cancelled by swinging or shaking the terminal. Or, the information terminal 31 may be configured to inform a user of a wrong digit and prompt to reenter. In the latter case, it turns out that the entries up to the wrong digit being correct, and this fact is notified to a user, from which the password's security function becomes substantially lowered. Thus, it is desirable to permit entry up to three times, for example, and in case of the failures being made for three times, the current password shall be changed to one of other passwords that were previously registered in advance for use of an auxiliary password.

FIG. 5 shows an example of user's operation with five patterns defined by the combinations of the direction and tilt of the information terminal 31, which will be used as a password in the embodiment.

A reference numeral 52 denotes a direction that is displayed on the display unit 34 of the information terminal 31 for the user to know a direction of the information terminal 31. A numeral 53 denotes a sign that is displayed on the display unit 34 of the information terminal 31 for the user to know a tilt of the information terminal 31. A numeral 54 is a sign that is displayed on the display unit 34 of the information terminal 31, by which the user can know the number of determining a pattern of direction and tilt of the information terminal 31 of this time.

(I) in FIG. 5 shows an initial pattern of direction and tilt of an information terminal, in which the information terminal 31 is directed to the north, and not tilted.

(II) in FIG. 5 shows a pattern 1 of direction and tilt of an information terminal, in which the information terminal 31 is directed to the north, and tilted upward.

(III) in FIG. 5 shows a pattern 2 of direction and tilt of an information terminal, in which the information terminal 31 is directed to the west, and tilted upward.

(IV) in FIG. 5 shows a pattern 3 of direction and tilt of an information terminal, in which the information terminal 31 is directed to the east, and tilted right up.

(V) in FIG. 5 shows a pattern 4 of direction and tilt of an information terminal, in which the information terminal 31 is directed to the south, and tilted downward.

In the embodiment of FIG. 5, a combination of the four patterns of (II) to (V) is used as a password. In this embodiment, each pattern is defined by a combination of four directions and five tilts, so that character's selection can be possibly made up to twenty characters, including different character types. For example, ten numeral numbers, zero to nine, and ten alphabet characters, such as A-J or a-j, can be combined one another, and entered as a password. It is also possible not to limit a character and to prevent an excess entry by issuing an alert when the user is going to enter twenty or more character types for setting a password. The above is explanation on the case that the password input operation example of FIG. 4 is performed.

### Second Embodiment

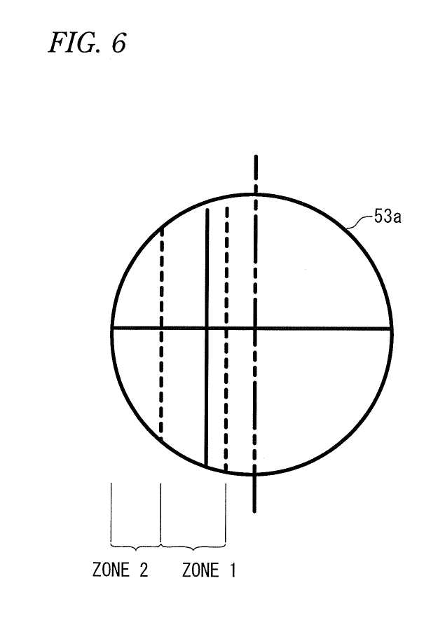

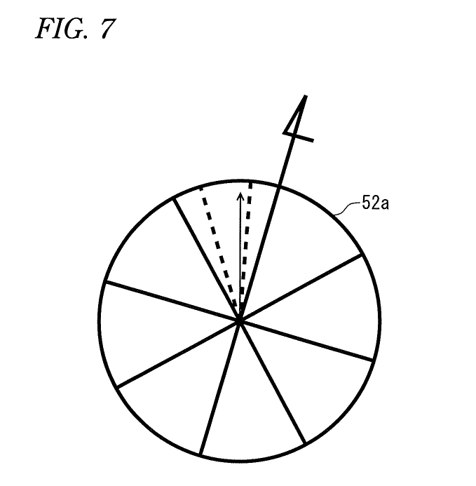

A second embodiment of the invention will be explained with reference to FIG. 6 and FIG. 7. Explanation of the part common to the first embodiment will be omitted.

FIG. 6 shows an idea to increase the information amount and operability of the sign 53 in order to know the tilt in FIG. 5. A semicircle indicated by a two-dot chain line in (III) of FIG. 5 is further divided into two zones by a broken line in order to indicate which zone a present tilt belongs to. This increases the number of combinations. It is also possible to use a pattern in which a Z axis is tilted not only to X and Y directions, but also tilted in a diagonal direction of the display unit.

FIG. 7 shows an idea to increase the information amount and operability of the direction 52 in order to know the direction of the information terminal 31 in FIG. 5. The display 52 is divided from four directions to eight directions, and further divided into sixteen directions by a broken line in order to indicate a present zone. In FIG. 7, a direction indicated by an arrow within a circle is in a range of north-northwest 22.5 degrees. This eliminates the necessity of extremely moving the information terminal 31, and increases the number of combinations.

By the above idea to increase the information amount, the limitation of character types can be decreased.

In the embodiment, by using a direction and tilt of an information terminal as a password, a user can enter a password of an information terminal without being regarded as entering a password by the people around. This is effect to prevent peeping. In other words, a password entry is difficult to be noticed by the people around, and a user is safe and strong against prying a password. As a result, this can provide an information terminal password authentication method that is easy to use and difficult to be noticed by the people around.

In solution of a problem of removing a password by combining a direction of an information terminal, a direction and tilt of an information terminal are detected by using a sensor, and a pattern of combining directions of the information terminal is used as a password. By using a combination of directions and tilts of an information terminal as a password, the user has only to memorize less information.

As an application, information indicating a direction of an information terminal is displayed on a screen of an information terminal for a user to know a direction and tilt of an information terminal when entering a password. Further, a user does not move an information terminal for a certain time when entering a password in order to determine a direction of an information terminal. A user can select a direction of an information terminal and the number of determining it as a password.

The invention is not to be limited to the embodiments described above. The invention may be embodied in other specific forms without departing from its spirit or essential characteristics. For example, although detection of a direction and tilt is comprehensively used, only a tilt may be detected in some cases.

The invention may be realized in various forms by appropriately combining the constituent elements disclosed in the embodiments discussed above. For example, some constituent elements may be deleted from all constituent elements indicated in the embodiments. Further, constituent elements according to a different embodiment may be appropriately combined.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electronic apparatus comprising:
a main body;
a first sensor configured to detect a tilt of the main body;
an input unit configured to accept entry of a password from a user; and
an authentication unit configured to execute user authentication based on the tilt detected by the first sensor and the password entered in the input unit.

2. The electronic apparatus of claim 1, further comprising:
a second sensor configured to detect an orientation of the main body in addition to the first sensor configured to detect a tilt,
wherein the authentication unit executes user authentication according to the tilt detected by the first sensor and the orientation detected by the second sensor.

3. The electronic apparatus of claim 1, further comprising:
a display unit,
wherein the display unit displays the tilt of the main body and an orientation of the main body according to a detection result of the first sensor.

4. The electronic apparatus of claim 1,
wherein the authentication unit executes user authentication when a detection result of the first sensor is unchanged for a predetermined time.

5. The electronic apparatus of claim 4,
wherein a display unit displays the number of determined times of a password pattern when a detection result of the first sensor is unchanged for a predetermined time.

6. A control method in an electronic apparatus including (i) a main body, (ii) a first sensor configured to detect a tilt of the main body, and (iii) an input unit configured to accept entry of a password from a user, the control method comprising:
detecting a tilt of the main body; and
executing user authentication based on the detected tilt and the entered password.

7. The control method of claim 6 in the electronic apparatus further including (iv) a second sensor configured to detect an orientation of the main body, the control method further comprising:
detecting an orientation of the main body in addition to the tilt detection; and
executing user authentication according to the detected tilt and the detected orientation.
